(19) United States
(12) Patent Application Publication
(10) Pub. No.: US 2025/0293425 A1
(43) Pub. Date: Sep. 18, 2025

(54) CIRCULARLY POLARIZED ANTENNA AND WEARABLE ELECTRONIC DEVICE

(71) Applicant: GUANGDONG COROS SPORTS TECHNOLOGY CO., LTD, Dongguan (CN)

(72) Inventor: Xianwei SHI, Dongguan (CN)

(21) Appl. No.: 19/223,980

(22) Filed: May 30, 2025

Related U.S. Application Data
(63) Continuation of application No. PCT/CN2023/122806, filed on Sep. 28, 2023.

(51) Int. Cl. H01Q 1/27; H01Q 1/36; H01Q 1/48; H01Q 15/24

(52) U.S. Cl. CPC H01Q 1/273; H01Q 1/36; H01Q 1/48; H01Q 15/24

(57) ABSTRACT

A circularly polarized antenna and a wearable electronic device are provided. The circularly polarized antenna includes a first arc-shaped radiator and a second arc-shaped radiator. The first arc-shaped radiator and the second arc-shaped radiator are arranged at an interval. The first arc-shaped radiator and the second arc-shaped radiator are located on a same circumference. One of the first arc-shaped radiator and the second arc-shaped radiator is provided with a first grounding point, the other one of the first arc-shaped radiator and the second arc-shaped radiator is provided with a feeding point, and the first arc-shaped radiator and the second arc-shaped radiator are configured to receive a first circularly-polarized signal.

### CROSS-REFERENCE TO RELATED APPLICATIONS

This application claims priority to and is a continuation of International Application No. PCT/CN2023/122806, filed on Sep. 28, 2023, the entire content of which is incorporated herein by reference.

### FIELD OF TECHNOLOGY

The following relates to the field of antenna technology, more particular to a circularly polarized antenna and a wearable electronic device.

### BACKGROUND

With the rapid development of wireless communication terminal technology, wearable electronic devices have come into view. The wearable electronic devices are equipped with internal circularly polarized antennas designed to receive circularly-polarized signals, so that the wearable electronic devices can possess positioning functionality.

The circularly polarized antenna in existing wearable electronic devices is installed on a watch ring. For non-metallic watch rings, a complete metal ring must be fabricated on the watch ring to form the circularly polarized antenna. However, due to the compact size and complex internal environment of wearable electronic devices, the design of circularly polarized antennas presents significant challenges.

### SUMMARY

One of the objectives of the embodiments of this application is to provide a circularly polarized antenna and a wearable electronic device, which can solve the problem of high design difficulty for circularly polarized antennas in wearable electronic devices.

Technical schemes adopted in the embodiments of the present application are as follows:

In accordance with a first aspect, an embodiment of the present application provides a circularly polarized antenna, which includes a first arc-shaped radiator and a second arc-shaped radiator. The first arc-shaped radiator and the second arc-shaped radiator are arranged at an interval. The first arc-shaped radiator and the second arc-shaped radiator are located on a same circumference, one of the first arc-shaped radiator and the second arc-shaped radiator is provided with a first grounding point, the other one of the first arc-shaped radiator and the second arc-shaped radiator is provided with a feeding point, and the first arc-shaped radiator and the second arc-shaped radiator are configured to receive a first circularly-polarized signal.

In a possible implementation of the first aspect, an arc length between a first end of the first arc-shaped radiator and a second end of the second arc-shaped radiator is smaller than an arc length between a second end of the first arc-shaped radiator and a first end of the second arc-shaped radiator, and an arc angle on the circumference between the first end of the first arc-shaped radiator and the second end of the second arc-shaped radiator is greater than or equal to 10 degrees and smaller than or equal to 30 degrees.

In a possible implementation of the first aspect, an equivalent length of the first arc-shaped radiator is equal to an equivalent length of the second arc-shaped radiator.

The feeding point is arranged at a first end portion of the first arc-shaped radiator, and the first grounding point is arranged at a first end portion of the second arc-shaped radiator.

Or alternatively,
the feeding point is arranged at a second end portion of the first arc-shaped radiator, and the first grounding point is arranged at a second end portion of the second arc-shaped radiator.

Or alternatively,
the first grounding point is arranged at the first end portion of the first arc-shaped radiator, and the feeding point is arranged at the first end portion of the second arc-shaped radiator;

Or alternatively,
the first grounding point is arranged at the second end portion of the first arc-shaped radiator, and the feeding point is arranged at the second end portion of the second arc-shaped radiator.

In a possible implementation of the first aspect, the circularly polarized antenna also includes a third arc-shaped radiator, the third arc-shaped radiator, the first arc-shaped radiator and the second arc-shaped radiator are arranged at intervals, the third arc-shaped radiator, the first arc-shaped radiator and the second arc-shaped radiator are located on the same circumference, and a second grounding point is provided on the third arc-shaped radiator.

The third arc-shaped radiator and the first arc-shaped radiator are configured to receive a second circularly-polarized signal, or alternatively, the third arc-shaped radiator and the second arc-shaped radiator are configured to receive the second circularly-polarized signal.

In a possible implementation of the first aspect, an arc length between the second end of the first arc-shaped radiator and a first end of the third arc-shaped radiator is smaller than an arc length between the first end of the first arc-shaped radiator and a second end of the third arc-shaped radiator, and an arc angle on the circumference between the second end of the first arc-shaped radiator and the first end of the third arc-shaped radiator is greater than or equal to 10 degrees and smaller than or equal to 30 degrees.

In a possible implementation of the first aspect, the first grounding point is arranged at the first end portion of the first arc-shaped radiator, the feeding point is arranged at the first end portion of the second arc-shaped radiator, and the second grounding point is arranged at a first end portion of the third arc-shaped radiator.

Or alternatively,
the feeding point is arranged at the first end portion of the first arc-shaped radiator, the first grounding point is arranged at the first end portion of the second arc-shaped radiator, and the second grounding point is arranged at the first end portion of the third arc-shaped radiator.

In a possible implementation of the first aspect, an arc length between the first end of the second arc-shaped radiator and the second end of the third arc-shaped radiator is smaller than an arc length between the second end of the second arc-shaped radiator and the first end of the third arc-shaped radiator, and an arc angle on the circumference between the first end of the second arc-shaped radiator and the second end of the third arc-shaped radiator is greater than or equal to 10 degrees and smaller than or equal to 30 degrees.

In a possible implementation of the first aspect, the feeding point is arranged at the first end portion of the first arc-shaped radiator, the first grounding point is arranged at the first end portion of the second arc-shaped radiator, and the second grounding point is arranged at the first end portion of the third arc-shaped radiator;

Or alternatively,
the feeding point is arranged at the first end portion of the first arc-shaped radiator, the first grounding point is arranged at the first end portion of the second arc-shaped radiator, and the second grounding point is arranged at the second end portion of the third arc-shaped radiator.

In a possible implementation of the first aspect, an equivalent length of the first arc-shaped radiator is different from an equivalent length of the second arc-shaped radiator.

The feeding point is arranged at a first end portion of the first arc-shaped radiator, and the first grounding point is arranged at a second end portion of the second arc-shaped radiator.

Or alternatively,
the feeding point is arranged at a second end portion of the first arc-shaped radiator, and the first grounding point is arranged at a first end portion of the second arc-shaped radiator.

Or alternatively,
the first grounding point is arranged at the first end portion of the first arc-shaped radiator, and the feeding point is arranged at the second end portion of the second arc-shaped radiator.

Or alternatively,
the first grounding point is arranged at the second end portion of the first arc-shaped radiator, and the feeding point is arranged at the first end portion of the second arc-shaped radiator.

In a possible implementation of the first aspect, the circularly polarized antenna also includes a third arc-shaped radiator, the third arc-shaped radiator, the first arc-shaped radiator and the second arc-shaped radiator are arranged at intervals, the third arc-shaped radiator, the first arc-shaped radiator and the second arc-shaped radiator are located on the same circumference, and a second grounding point is provided on the third arc-shaped radiator.

The third arc-shaped radiator and the first arc-shaped radiator are configured to receive a second circularly-polarized signal.

In a possible implementation of the first aspect, an arc length between the second end of the first arc-shaped radiator and the first end of the third arc-shaped radiator is smaller than an arc length between the first end of the first arc-shaped radiator and the second end of the third arc-shaped radiator, and an arc angle on the circumference between the second end of the first arc-shaped radiator and the first end of the third arc-shaped radiator is greater than or equal to 10 degrees and smaller than or equal to 30 degrees.

In a possible implementation of the first aspect, the first grounding point is arranged at the first end portion of the first arc-shaped radiator, the feeding point is arranged at the second end portion of the second arc-shaped radiator, and the second grounding point is arranged at the first end portion of the third arc-shaped radiator.

Or alternatively,
the feeding point is arranged at the first end portion of the first arc-shaped radiator, the first grounding point is arranged at the second end portion of the second arc-shaped radiator, and the second grounding point is arranged at the first end portion of the third arc-shaped radiator.

In accordance with a second aspect, an embodiment of the present application provides a wearable electronic device, which includes a housing, a position determination element, and a circularly polarized antenna described in any one of the first aspects. The housing includes a bottom wall and a side wall connected to the bottom wall, the circularly polarized antenna is provided on the side wall, and the position determination element is coupled with the circularly polarized antenna.

The circularly polarized antenna is configured to receive a first circularly-polarized signal and transmit the first circularly-polarized signal to the position determination element, and the position determination element is configured to determine a current geographical location according to the first circularly-polarized signal.

The circularly polarized antenna provided according to the embodiments of the present application includes a first arc-shaped radiator and a second arc-shaped radiator. The first arc-shaped radiator and the second arc-shaped radiator are arranged at an interval. The first arc-shaped radiator and the second arc-shaped radiator are located on the same circumference, one of the first arc-shaped radiator and the second arc-shaped radiator is provided with a first grounding point, the other one of the first arc-shaped radiator and the second arc-shaped radiator is provided with a feeding point. The first arc-shaped radiator and the second arc-shaped radiator are configured to receive a first circularly-polarized signal.

The circularly polarized antenna provided in the embodiments of the present application utilizes two arc-shaped radiators (the first arc-shaped radiator and the second arc-shaped radiator) to form a circularly polarized antenna, without the need to fabricate a complete circular radiator, which reduces the length of the antenna and is conducive to the miniaturization design of the circularly polarized antenna, meanwhile, the two arc-shaped radiators can be flexibly designed in a wearable electronic device, thereby the design difficulty of the circularly polarized antenna is reduced.

### BRIEF DESCRIPTION OF THE DRAWINGS

In order to illustrate the technical schemes in the embodiments of the present application more clearly, the drawings required for use in description of the embodiments are briefly introduced below. Obviously, the drawings described below are merely some embodiments of the present application. For ordinary technicians in this field, other drawings may be obtained based on these drawings without paying creative efforts.

FIG. 1 is a schematic structural diagram of a circularly polarized antenna provided in an embodiment of the present application;

FIG. 2 is a current distribution diagram when an equivalent length of a first arc-shaped radiator is equal to that of a second arc-shaped radiator, and the circularly polarized antenna receives a first frequency signal in a first mode or a second frequency signal in a second mode, provided in an embodiment of the present application;

FIG. 3 is a schematic structural diagram of a circularly polarized antenna provided in another embodiment of the present application;

FIG. 4 is a schematic structural diagram of a circularly polarized antenna provided in another embodiment of the present application;

FIG. 5 is a schematic structural diagram of a circularly polarized antenna provided in another embodiment of the present application;

FIG. 6 is a schematic structural diagram of a circularly polarized antenna provided in another embodiment of the present application;

FIG. 7 is a current distribution diagram when the equivalent length of the first arc-shaped radiator is different from the equivalent length of the second arc-shaped radiator, and the circularly polarized antenna receives a third frequency signal in the first mode or a fourth frequency signal in the second mode, provided in an embodiment of the present application;

FIG. 8 is a schematic structural diagram of a circularly polarized antenna provided in another embodiment of the present application;

FIG. 9 is a schematic structural diagram of a circularly polarized antenna provided in another embodiment of the present application.

In the figures: 100, first arc-shaped radiator; 200, second arc-shaped radiator; 300, feeding point; 400, first grounding point; 500, third arc-shaped radiator; 600, second grounding point.

### DETAILED DESCRIPTION OF THE EMBODIMENTS

In the following description, for the purpose of explanation rather than limitation, specific details such as specific system structures and technologies are proposed so as to provide a thorough understanding of the embodiments of the present application. However, it should be clear to persons skilled in the art that the present application may also be implemented in other embodiments without these specific details. In other cases, detailed descriptions of well-known systems, devices, circuits, and methods are omitted to avoid unnecessary details that hinder the description of the present application.

It should be understood that, when used in the specification and the appended claims of this application, the term “includes” indicates the presence of the described features, wholes, steps, operations, elements, and/or components, but does not exclude the presence or addition of one or more other features, wholes, steps, operations, elements, components, and/or their collections.

It should also be understood that the term “and/or” used in the specification and appended claims of this application refers to any combination of one or more of the associated listed items and all possible combinations thereof, which include these combinations.

As used in the specification and appended claims of this application, the term “if” may be interpreted as “when . . . ” or “once” or “in response to a determination” or “in response to a detection” depending on the context. Similarly, the phrase “if determined” or “if [described condition or event] is detected” may be interpreted as meaning “once determined” or “in response to determining” or “once [described condition or event] is detected” or “in response to detecting [described condition or event]” according to the context.

In addition, in the description of the specification and appended claims of this application, the terms “first”, “second”, “third”, etc. are only used to distinguish the description and cannot be understood as indicating or implying relative importance.

The description of referring to “one embodiment” or “some embodiments” in the specification of this application means that one or more embodiments of the present application include specific features, structures or characteristics described in combination with the embodiment. Thus, the sentences “in one embodiment”, “in some embodiments”, “in other embodiments”, “in some other embodiments”, etc. appearing in different places in this disclosure do not necessarily refer to the same embodiment, but mean “one or more but not all embodiments”, unless otherwise specifically emphasized in other ways. The terms “including”, “comprising”, “having” and their variations all mean “including but not limited to”, unless otherwise specifically emphasized in other ways.

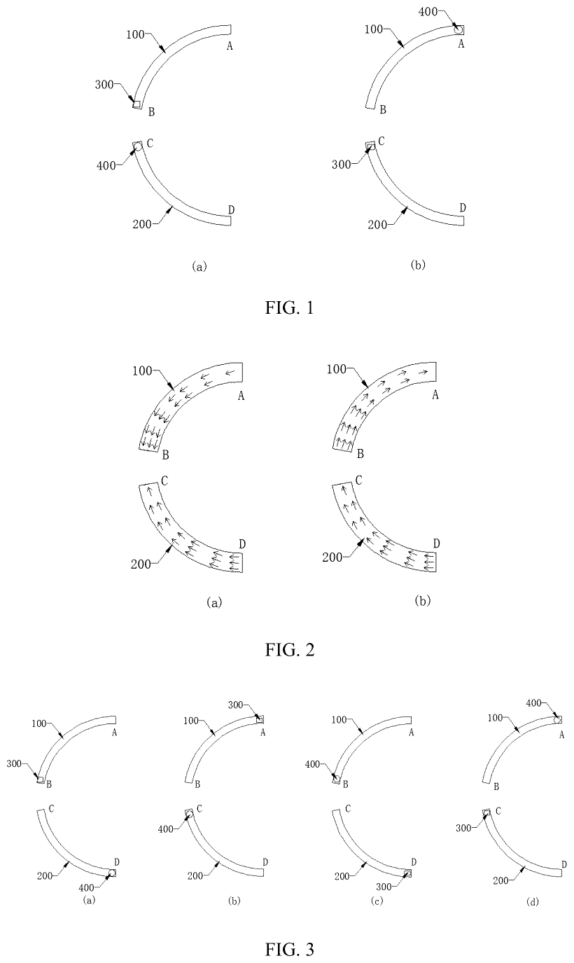

FIG. 1 shows a schematic structural diagram of a circularly polarized antenna provided in an embodiment of the present application. As shown in FIG. 1, the circularly polarized antenna includes a first arc-shaped radiator 100 and a second arc-shaped radiator 200. The first arc-shaped radiator 100 and the second arc-shaped radiator 200 are arranged at an interval, the first arc-shaped radiator 100 and the second arc-shaped radiator 200 are located on the same circumference, one of the first arc-shaped radiator 100 and the second arc-shaped radiator 200 is provided with a first grounding point 400, the other one of the first arc-shaped radiator 100 and the second arc-shaped radiator 200 is provided with a feeding point 300, and the first arc-shaped radiator 100 and the second arc-shaped radiator 200 are configured to receive a first circularly-polarized signal.

Specifically, the first arc-shaped radiator 100 and the second arc-shaped radiator 200 are arranged at an interval, and the first arc-shaped radiator 100 and the second arc-shaped radiator 200 are located on the same circumference. The first grounding point 400 is provided on one of the first arc-shaped radiator 100 and the second arc-shaped radiator 200, and the feeding point 300 is provided on the other one of the first arc-shaped radiator 100 and the second arc-shaped radiator 200. Part (a) of FIG. 1 shows that the feeding point 300 is provided on the first arc-shaped radiator 100, and the first grounding point 400 is provided on the second arc-shaped radiator 200. Part (b) of FIG. 1 shows that the first grounding point 400 is provided on the first arc-shaped radiator 100, and the feeding point 300 is provided on the second arc-shaped radiator 200.

Through the above configuration, a circularly polarized antenna is formed by means of the first arc-shaped radiator 100 and the second arc-shaped radiator 200, which can receive the first circularly-polarized signal. Compared with the existing technologies that requires fabricating a complete circular metal ring on the watch ring to form a circularly polarized antenna, the circularly polarized antenna provided in the embodiments of this application utilizes two arc-shaped radiators (the first arc-shaped radiator 100 and the second arc-shaped radiator 200) to form the circularly polarized antenna. This eliminates the need to fabricate a complete circular radiator, which reduces the length of the antenna and is conducive to the miniaturization design of the circularly polarized antenna. Additionally, the two arc-shaped radiators can be flexibly designed within the wearable electronic device, lowering the design complexity of the circularly polarized antenna.

Designers can adjust the equivalent lengths of the first arc-shaped radiator 100 and the second arc-shaped radiator 200 according to actual requirements, but it is necessary to ensure that the equivalent lengths of the first arc-shaped radiator 100 and the second arc-shaped radiator 200 are identical. so that the circularly polarized antenna receives a first frequency signal and a second frequency signal. Here, a difference in frequency between the first frequency signal and the second frequency signal is smaller than a preset frequency, that is, the frequency of the first frequency signal is close to the frequency of the second frequency signal.

Part (a) of FIG. 2 shows the current distribution diagram on the first arc-shaped radiator 100 and the second arc-shaped radiator 200 when the circularly polarized antenna receives the first frequency signal in the first mode and the equivalent length of the first arc-shaped radiator 100 is equal to the equivalent length of the second arc-shaped radiator 200. The current on the first arc-shaped radiator 100 and the current of the second arc-shaped radiator 200 are synthesized forming a current that flows laterally left and right. Part (b) of FIG. 2 shows the current distribution diagram on the first arc-shaped radiator 100 and the second arc-shaped radiator 200 when the circularly polarized antenna receives the second frequency signal in the second mode. The current on the first arc-shaped radiator 100 and the current on the second arc-shaped radiator 200 are synthesized forming a current that flows vertically up and down.

It can be seen that there is a target frequency signal having a frequency between the first frequency and the second frequency. The synthesized current of the first arc-shaped radiator 100 and the second arc-shaped radiator 200 when the circularly polarized antenna receives the target frequency signal in the first mode, and the synthesized current of the first arc-shaped radiator 100 and the second arc-shaped radiator 200 when the circularly polarized antenna receives the target frequency signal in the second mode are perpendicular to each other and have a phase difference of 90 degrees. Thus, the first arc-shaped radiator 100 and the second arc-shaped radiator 200 form a circularly polarized antenna, which can receive the first circularly-polarized signal of the target frequency.

Exemplarily, a signal having a frequency between 2.2 GHz and 2.4 GHz (for example, a signal having a frequency of 2.32 GHZ) may be determined when the current synthesized by the first arc-shaped radiator 100 and the second arc-shaped radiator 200 when the circularly polarized antenna receives a 2.2 GHz signal in the first mode and the current synthesized by the first arc-shaped radiator 100 and the second arc-shaped radiator 200 when the circularly polarized antenna receives a 2.4 GHz signal in the second mode are nearly perpendicular to each other and have the phase difference of 90 degrees. By configuring the current synthesized by the first arc-shaped radiator 100 and the second arc-shaped radiator 200 when the circularly polarized antenna receives a 2.32 GHz signal in the first mode and the current synthesized by the first arc-shaped radiator 100 and the second arc-shaped radiator 200 when the circularly polarized antenna receives a 2.32 GHz signal in the second mode to be nearly perpendicular to each other and have the phase difference of 90 degrees, the first arc-shaped radiator 100 and the second arc-shaped radiator 200 are enabled to form a circularly polarized antenna which can receive a circularly-polarized signal with a frequency of 2.32 GHz.

It should be noted that in the current distribution diagram shown in the present application, the density of arrows represents the magnitude of the current. The denser the arrows, the greater the current; the sparser the arrows, the smaller the current. The direction of the arrows indicates the direction of the current.

In some embodiments, an arc length between a first end B of the first arc-shaped radiator 100 and a second end C of the second arc-shaped radiator 200 is smaller than an arc length between a second end A of the first arc-shaped radiator 100 and a first end D of the second arc-shaped radiator 200, and an arc angle on the circumference between the first end B of the first arc-shaped radiator 100 and the second end C of the second arc-shaped radiator 200 is greater than or equal to 10 degrees and smaller than or equal to 30 degrees.

Specifically, the arc length between the first end B of the first arc-shaped radiator 100 and the second end C of the second arc-shaped radiator 200 is smaller than the arc length between the second end A of the first arc-shaped radiator 100 and the first end D of the second arc-shaped radiator 200, and the arc angle on the circumference between the first end B of the first arc-shaped radiator 100 and the second end C of the second arc-shaped radiator 200 is greater than or equal to 10 degrees and smaller than or equal to 30 degrees. That is, a line connecting the first end B of the first arc-shaped radiator 100 and a center of the circumference is a first line, a line connecting the second end C of the second arc-shaped radiator 200 and the center of the circumference is a second line, and the first line and the second line form an included angle which is greater than or equal to 10 degrees and smaller than or equal to 30 degrees. In addition to this, the included angle between the first line and the second line may also be configured to be greater than or equal to 10 degrees and smaller than or equal to 20 degrees, and the included angle between the first line and the second line may also be configured to be greater than or equal to 15 degrees and smaller than or equal to 20 degrees. By reasonably configuring the included angle between the first line and the second line, the first arc-shaped radiator 100 is brought close to the second arc-shaped radiator 200. When the feeding point 300 is provided on the first arc-shaped radiator 100 and the first grounding point 400 is provided on the second arc-shaped radiator 200, the first arc-shaped radiator 100 can excite the second arc-shaped radiator 200, enabling it to receive the first circularly-polarized signal, and generate a resonant current according to the first circularly-polarized signal. When the feeding point 300 is provided on the second arc-shaped radiator 200 and the first grounding point 400 is provided on the first arc-shaped radiator 100, the second arc-shaped radiator 200 can excite the first arc-shaped radiator 100 to receive the first circularly-polarized signal, and generate a resonant current according to the first circularly-polarized signal.

In the meantime, the first arc-shaped radiator 100 is arranged close to the second arc-shaped radiator 200 can also ensure that the current synthesized by the first arc-shaped radiator 100 and the second arc-shaped radiator 200 when the first circularly-polarized signal is received in the first mode is perpendicular to the current synthesized by the first arc-shaped radiator 100 and the second arc-shaped radiator 200 when the first circularly-polarized signal is received in the second mode, to allow the first arc-shaped radiator 100 and the second arc-shaped radiator 200 to form a circularly polarized antenna which can receive the first circularly-polarized signal.

In some embodiments, as shown in FIG. 3, an equivalent length of the first arc-shaped radiator 100 is equal to an equivalent length of the second arc-shaped radiator 200. The feeding point 300 is arranged at a first end portion of the first arc-shaped radiator 100, and the first grounding point 400 is arranged at a first end portion of the second arc-shaped radiator 200 (as shown in part (a) of FIG. 3). Or alternatively, the feeding point 300 is arranged at a second end portion of the first arc-shaped radiator 100, and the first grounding point 400 is arranged at a second end portion of the second arc-shaped radiator 200 (as shown in part (b) of FIG. 3).

Or alternatively, the first grounding point 400 is arranged at the first end portion of the first arc-shaped radiator 100, and the feeding point 300 is arranged at the first end portion of the second arc-shaped radiator 200 (as shown in part (c) of FIG. 3). Or alternatively, the first grounding point 400 is arranged at the second end portion of the first arc-shaped radiator 100, and the feeding point 300 is arranged at the second end portion of the second arc-shaped radiator 200 (as shown in part (d) of FIG. 3).

Specifically, when the feeding point 300 is arranged at the first end portion of the first arc-shaped radiator 100 and the first grounding point 400 is arranged at the first end portion of the second arc-shaped radiator 200 (as shown in part (a) of FIG. 3), the first arc-shaped radiator 100 and the second arc-shaped radiator 200 may form a left-handed circularly polarized antenna, and the first arc-shaped radiator 100 and the second arc-shaped radiator 200 can receive a left-handed circularly-polarized signal.

When the feeding point 300 is arranged at the second end portion of the first arc-shaped radiator 100 and the first grounding point 400 is arranged at the second end portion of the second arc-shaped radiator 200 (as shown in part (b) of FIG. 3), the first arc-shaped radiator 100 and the second arc-shaped radiator 200 may form a left-handed circularly polarized antenna, and the first arc-shaped radiator 100 and the second arc-shaped radiator 200 can receive a left-handed circularly-polarized signal.

When the first grounding point 400 is arranged at the first end portion of the first arc-shaped radiator 100 and the feeding point 300 is arranged at the first end portion of the second arc-shaped radiator 200 (as shown in part (c) of FIG. 3), the first arc-shaped radiator 100 and the second arc-shaped radiator 200 may form a right-hand circularly polarized antenna, and the first arc-shaped radiator 100 and the second arc-shaped radiator 200 can receive a right-hand circularly-polarized signal.

When the first grounding point 400 is arranged at the second end portion of the first arc-shaped radiator 100 and the feeding point 300 is arranged at the second end portion of the second arc-shaped radiator 200 (as shown in part (d) of FIG. 3), the first arc-shaped radiator 100 and the second arc-shaped radiator 200 may form a right-hand circularly polarized antenna, and the first arc-shaped radiator 100 and the second arc-shaped radiator 200 can receive a right-hand circularly-polarized signal.

It should be noted that the first end portion of the first arc-shaped radiator 100 includes a first end B of the first arc-shaped radiator 100 and an area near the first end B, and the second end portion of the first arc-shaped radiator 100 includes the second end A of the first arc-shaped radiator 100 and an area near the second end A. The first end portion of the second arc-shaped radiator 200 includes the first end D of the second arc-shaped radiator 200 and an area near the first end D, and the second end portion of the second arc-shaped radiator 200 includes the second end C of the second arc-shaped radiator 200 and an area near the second end C.

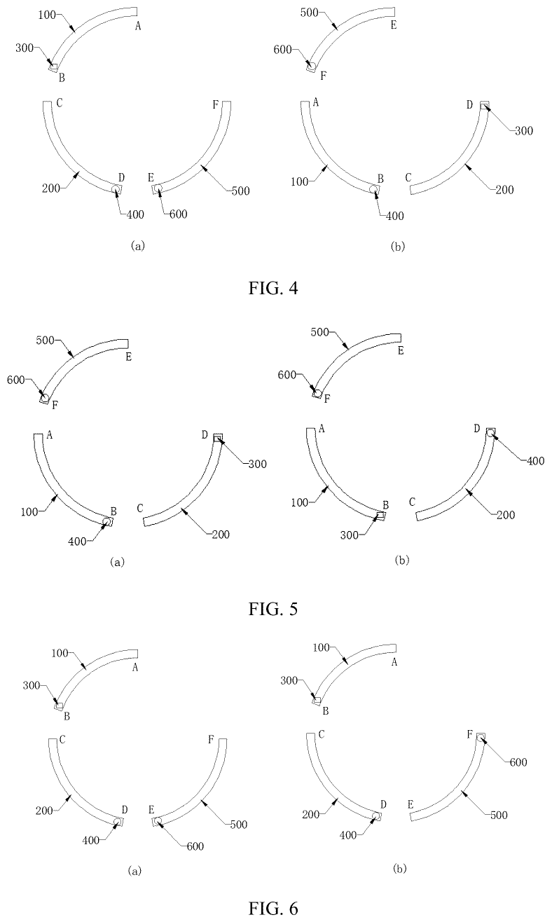

In some embodiments, as shown in FIG. 4, the circularly polarized antenna further includes a third arc-shaped radiator 500. The third arc-shaped radiator 500, the first arc-shaped radiator 100 and the second arc-shaped radiator 200 are arranged at intervals. The third arc-shaped radiator 500, the first arc-shaped radiator 100 and the second arc-shaped radiator 200 are located on the same circumference, and a second grounding point 600 is provided on the third arc-shaped radiator 500.

Specifically, when the third arc-shaped radiator 500 is arranged close to the first arc-shaped radiator 100 (as shown in part (b) of FIG. 4), the third arc-shaped radiator 500 and the first arc-shaped radiator 100 are capable of receiving a second circularly-polarized signal, and the principle is the same as the principle of the first arc-shaped radiator 100 and the second arc-shaped radiator 200 receiving the first circularly-polarized signal, which will not be repeated here. When the third arc-shaped radiator 500 is arranged close to the second arc-shaped radiator 200 (as shown in part (a) of FIG. 4), the third arc-shaped radiator 500 and the second arc-shaped radiator 200 are capable of receiving the second circularly-polarized signal, and the principle is the same as the principle of the first arc-shaped radiator 100 and the second arc-shaped radiator 200 receiving the first circularly-polarized signal, which will not be repeated here.

In existing wearable electronic devices, a complete circular ring antenna can only receive a circularly-polarized signal of one frequency, while in the present application, three arc-shaped radiators (the first arc-shaped radiator 100, the second arc-shaped radiator 200 and the third arc-shaped radiator 500) are provided which can receive circularly-polarized signals of two frequencies, thus the number of received circularly-polarized signals is increased, thereby allowing the wearable electronic device to be positioned according to circularly-polarized signals of different frequencies. When a circularly-polarized signal of one frequency cannot be used, the wearable electronic device can use another circularly-polarized signal for positioning, which enhances the stability of the positioning function of the wearable electronic device.

Meanwhile, the three arc-shaped radiators (the first arc-shaped radiator 100, the second arc-shaped radiator 200 and the third arc-shaped radiator 500) are arranged at intervals, which increases the flexibility of the design of the three arc-shaped radiators in wearable electronic devices and reduces the difficulty of designing and installing circularly polarized antennas.

In some embodiments, an arc length between the second end A of the first arc-shaped radiator 100 and a first end F of the third arc-shaped radiator 500 is smaller than an arc length between the first end B of the first arc-shaped radiator 100 and a second end E of the third arc-shaped radiator 500 (as shown in part (b) of FIG. 4), and an arc angle on the circumference between the second end of the first arc-shaped radiator 100 and the first end of the third arc-shaped radiator 500 is greater than or equal to 10 degrees and smaller than or equal to 30 degrees.

Specifically, the arc length between the second end A of the first arc-shaped radiator 100 and the first end F of the third arc-shaped radiator 500 is smaller than the arc length between the first end B of the first arc-shaped radiator 100 and the second end E of the third arc-shaped radiator 500, and the arc angle on the circumference between the second end of the first arc-shaped radiator 100 and the first end of the third arc-shaped radiator 500 is greater than or equal to 10 degrees and smaller than or equal to 30 degrees. That is, a line connecting the second end A of the first arc-shaped radiator 100 and the center of the circle is a third line, a line connecting the first end F of the third arc-shaped radiator 500 and the center of the circle is a fourth line, and the third line and the fourth line form an included angle which is greater than or equal to 10 degrees and smaller than or equal to 30 degrees. In addition to this, the included angle between the third line and the fourth line may also be configured to be greater than or equal to 10 degrees and smaller than or equal to 20 degrees, and the included angle between the third line and the fourth line may also be configured to be greater than or equal to 15 degrees and smaller than or equal to 20 degrees. By reasonably configuring the included angle between the third line and the fourth line, the third arc-shaped radiator 500 is brought close to the first arc-shaped radiator 100. In case that the feeding point 300 is provided on the first arc-shaped radiator 100, the first grounding point 400 is provided on the second arc-shaped radiator 200, and the second grounding point 600 is provided on the third arc-shaped radiator 500, then the first arc-shaped radiator 100 when receiving the second circularly-polarized signal can excite the third arc-shaped radiator 500 to generate a resonant current, so that the first arc-shaped radiator 100 and the third arc-shaped radiator 500 can receive the second circularly-polarized signal.

In case that the first grounding point 400 is provided on the first arc-shaped radiator 100, the feeding point 300 is provided on the second arc-shaped radiator 200, and the second grounding point 600 is provided on the third arc-shaped radiator 500, then the second arc-shaped radiator 200 when receiving the second circularly-polarized signal can excite the first arc-shaped radiator 100 to generate a resonant current, and the first arc-shaped radiator 100 excites the third arc-shaped radiator 500 to generate a resonant current, so that the first arc-shaped radiator 100 and the third arc-shaped radiator 500 can receive the second circularly-polarized signal.

In some embodiments, as shown in FIG. 5, the first grounding point 400 is disposed at the first end portion of the first arc-shaped radiator 100, the feeding point 300 is disposed at the first end portion of the second arc-shaped radiator 200, and the second grounding point 600 is disposed at a first end portion of the third arc-shaped radiator 500 (as shown in part (a) of FIG. 5). Or alternatively, the feeding point 300 is disposed at the first end portion of the first arc-shaped radiator 100, the first grounding point 400 is disposed at the first end portion of the second arc-shaped radiator 200, and the second grounding point 600 is disposed at the first end portion of the third arc-shaped radiator 500 (as shown in part (b) of FIG. 5).

Specifically, as shown in part (a) of FIG. 5, the first grounding point 400 is arranged at the first end portion of the first arc-shaped radiator 100, the feeding point 300 is arranged at the first end portion of the second arc-shaped radiator 200, and the second grounding point 600 is arranged at the first end portion of the third arc-shaped radiator 500. The first arc-shaped radiator 100 and the second arc-shaped radiator 200 form a right-hand circularly polarized antenna, which can receive a right-hand circularly-polarized signal (i.e., the first circularly-polarized signal). The first arc-shaped radiator 100 and the third arc-shaped radiator 500 form a left-hand circularly polarized antenna, which can receive a left-hand circularly-polarized signal (i.e., the second circularly-polarized signal).

As shown in part (b) of FIG. 5, the feeding point 300 is arranged at the first end portion of the first arc-shaped radiator 100, the first grounding point 400 is arranged at the first end portion of the second arc-shaped radiator 200, and the second grounding point 600 is arranged at the first end portion of the third arc-shaped radiator 500. The first arc-shaped radiator 100 and the second arc-shaped radiator 200 form a left-hand circularly polarized antenna, which can receive a left-hand circularly-polarized signal (i.e., the first circularly-polarized signal). The first arc-shaped radiator 100 and the third arc-shaped radiator 500 form a right-hand circularly polarized antenna, which can receive a right-hand circularly-polarized signal (i.e., the second circularly-polarized signal).

It should be noted that the first end portion of the third arc-shaped radiator 500 includes the first end F of the third arc-shaped radiator 500 and an area near the first end F, and a second end portion of the third arc-shaped radiator 500 includes the second end E of the third arc-shaped radiator 500 and an area near the second end E.

In some embodiments, as shown in FIG. 6, an arc length between the first end D of the second arc-shaped radiator 200 and the second end E of the third arc-shaped radiator 500 is smaller than an arc length between the second end C of the second arc-shaped radiator 200 and the first end F of the third arc-shaped radiator 500, and an arc angle on the circumference between the first end of the second arc-shaped radiator 200 and the second end of the third arc-shaped radiator 500 is greater than or equal to 10 degrees and smaller than or equal to 30 degrees.

Specifically, the arc length between the first end D of the second arc-shaped radiator 200 and the second end E of the third arc-shaped radiator 500 is smaller than the arc length between the second end C of the second arc-shaped radiator 200 and the first end F of the third arc-shaped radiator 500, and the arc angle on the circumference between the first end of the second arc-shaped radiator 200 and the second end of the third arc-shaped radiator 500 is greater than or equal to 10 degrees and smaller than or equal to 30 degrees. That is, a line connecting the first end D of the second arc-shaped radiator 200 and the center of the circle is a fifth line, a line connecting the second end E of the third arc-shaped radiator 500 and the center of the circle is a sixth line, and the fifth line and the sixth line form an included angle which is greater than or equal to 10 degrees and smaller than or equal to 30 degrees. In addition to this, the included angle between the fifth line and the sixth line may also be configured to be greater than or equal to 10 degrees and smaller than or equal to 20 degrees. The included angle between the fifth line and the sixth line may also be configured to be greater than or equal to 15 degrees and smaller than or equal to 20 degrees. By reasonably configuring the included angle between the fifth line and the sixth line, the third arc-shaped radiator 500 is brought close to the second arc-shaped radiator 200. In case that the feeding point 300 is provided on the second arc-shaped radiator 200, the first grounding point 400 is provided on the first arc-shaped radiator 100, and the second grounding point 600 is provided on the third arc-shaped radiator 500, then the second arc-shaped radiator 200 when receiving the second circularly-polarized signal can excite the third arc-shaped radiator 500 to generate a resonant current, so that the second arc-shaped radiator 200 and the third arc-shaped radiator 500 can receive the second circularly-polarized signal.

In case that the first grounding point 400 is provided on the second arc-shaped radiator 200, the feeding point 300 is provided on the first arc-shaped radiator 100, and the second grounding point 600 is provided on the third arc-shaped radiator 500, then the first arc-shaped radiator 100 when receiving the second circularly-polarized signal can excite the second arc-shaped radiator 200 to generate a resonant current, and then the second arc-shaped radiator 200 excites the third arc-shaped radiator 500 to generate a resonant current, so that the second arc-shaped radiator 200 and the third arc-shaped radiator 500 can receive the second circularly-polarized signal.

In some embodiments, as shown in FIG. 6, the feeding point 300 is arranged at the first end portion of the first arc-shaped radiator 100, the first grounding point 400 is arranged at the first end portion of the second arc-shaped radiator 200, and the second grounding point 600 is arranged at the first end portion of the third arc-shaped radiator 500 (as shown in part (b) of FIG. 6). Or alternatively, the feeding point 300 is arranged at the first end portion of the first arc-shaped radiator 100, the first grounding point 400 is arranged at the first end portion of the second arc-shaped radiator 200, and the second grounding point 600 is arranged at the second end portion of the third arc-shaped radiator 500 (as shown in part (a) of FIG. 6).

Specifically, as shown in part (a) of FIG. 6, the feeding point 300 is arranged at the first end portion of the first arc-shaped radiator 100, the first grounding point 400 is arranged at the first end portion of the second arc-shaped radiator 200, and the second grounding point 600 is arranged at the second end portion of the third arc-shaped radiator 500. The first arc-shaped radiator 100 and the second arc-shaped radiator 200 form a left-hand circularly polarized antenna, which can receive a left-hand circularly-polarized signal (i.e., the first circularly-polarized signal). The second arc-shaped radiator 200 and the third arc-shaped radiator 500 form a right-hand circularly polarized antenna, which can receive a right-hand circularly-polarized signal (i.e., the second circularly-polarized signal).

As shown in part (b) of FIG. 6, the feeding point 300 is arranged at the first end portion of the first arc-shaped radiator 100, the first grounding point 400 is arranged at the first end portion of the second arc-shaped radiator 200, and the second grounding point 600 is arranged at the second end portion of the third arc-shaped radiator 500. The first arc-shaped radiator 100 and the second arc-shaped radiator 200 form a left-hand circularly polarized antenna, which can receive a left-hand circularly-polarized signal (i.e., the first circularly-polarized signal). The second arc-shaped radiator 200 and the third arc-shaped radiator 500 form a right-hand circularly polarized antenna, which can receive a right-hand circularly-polarized signal (i.e., the second circularly-polarized signal).

The designers can design the equivalent length of the first arc-shaped radiator 100 and the equivalent length of the second arc-shaped radiator 200 according to actual requirements. Here, the equivalent length of the first arc-shaped radiator 100 is different from the equivalent length of the second arc-shaped radiator 200, so that the circularly polarized antenna can receive a third frequency signal and a fourth frequency signal. A difference in frequency between the third frequency signal and fourth frequency signal is smaller than a preset frequency, that is, the frequency of the third frequency signal is close to the frequency of the fourth frequency signal.

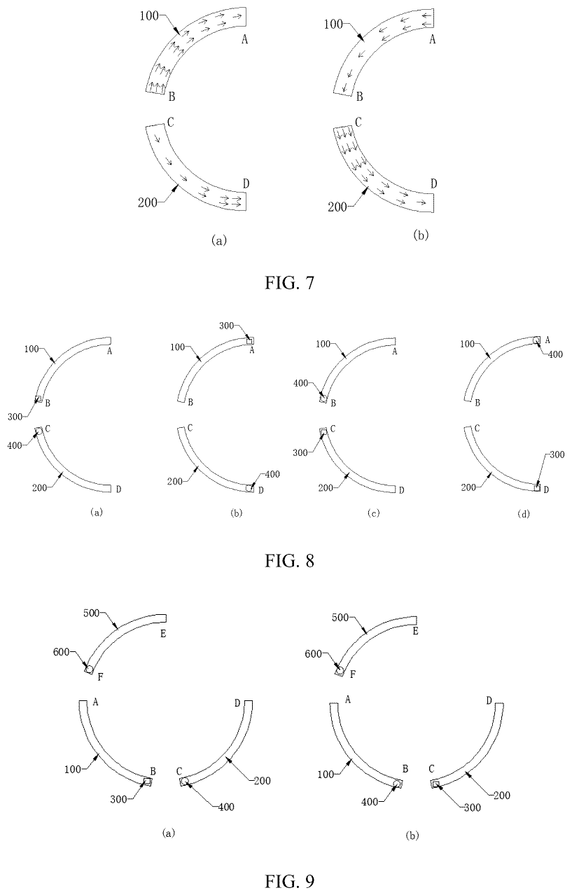

In case that the equivalent length of the first arc-shaped radiator 100 is greater than the equivalent length of the second arc-shaped radiator 200, the resonant current generated on the first arc-shaped radiator 100 and the second arc-shaped radiator 200 when the circularly polarized antenna receives the third frequency signal in the first mode is as shown in part (a) of FIG. 7. The current on the first arc-shaped radiator 100 is greater than the current on the second arc-shaped radiator 200, and the synthesized current of the first arc-shaped radiator 100 and the second arc-shaped radiator 200 includes a stronger current flowing horizontally left and right and a weaker current flowing vertically up and down. The resonant current generated on the first arc-shaped radiator 100 and the second arc-shaped radiator 200 when the circularly polarized antenna receives the fourth frequency signal in the second mode is as shown in part (b) of FIG. 7, the current on the first arc-shaped radiator 100 is smaller than the current on the second arc-shaped radiator 200, and the synthesized current of the first arc-shaped radiator 100 and the second arc-shaped radiator 200 includes a stronger current flowing vertically up and down and a weaker current flowing horizontally left and right.

It can be seen that there is a target frequency signal having a frequency between the third frequency and the fourth frequency. The current synthesized by the first arc-shaped radiator 100 and the second arc-shaped radiator 200 when the circularly polarized antenna receives the target frequency signal in the first mode and the current synthesized by the first arc-shaped radiator 100 and the second arc-shaped radiator 200 when the circularly polarized antenna receives the target frequency signal in the second mode are perpendicular to each other and has a phase difference of 90 degrees. Thereby, the first arc-shaped radiator 100 and the second arc-shaped radiator 200 form a circularly polarized antenna that can receive the first circularly-polarized signal of the target frequency.

Exemplarily, a signal having a frequency between 2.2 GHz and 2.4 GHz (for example, a signal having a frequency of 2.32 GHz) can be determined when the current synthesized by the first arc-shaped radiator 100 and the second arc-shaped radiator 200 when the circularly polarized antenna receives a 2.2 GHz signal in the first mode and the current synthesized by the first arc-shaped radiator 100 and the second arc-shaped radiator 200 when the circularly polarized antenna receives a 2.4 GHz signal in the second mode are nearly perpendicular to each other and have the phase difference of 90 degrees. By configuring the current synthesized by the first arc-shaped radiator 100 and the second arc-shaped radiator 200 when the circularly polarized antenna receives a 2.32 GHz signal in the first mode and the current synthesized by the first arc-shaped radiator 100 and the second arc-shaped radiator 200 when the circularly polarized antenna receives a 2.32 GHz signal in the second mode to be nearly perpendicular to each other and have the phase difference of 90 degrees, the first arc-shaped radiator 100 and the second arc-shaped radiator 200 are enabled to form a circularly polarized antenna which can receive a circularly-polarized signal with a frequency of 2.32 GHz.

In case that the equivalent length of the first arc-shaped radiator 100 is smaller than the equivalent length of the second arc-shaped radiator 200, the current on the first arc-shaped radiator 100 is smaller than the current on the second arc-shaped radiator 200 when the third frequency signal is received by the circularly polarized antenna in the first mode. The current on the first arc-shaped radiator 100 is greater than the current on the second arc-shaped radiator 200 when the fourth frequency signal is received by the circularly polarized antenna in the second mode. The first arc-shaped radiator 100 and the second arc-shaped radiator 200 can receive the first circularly-polarized signal. The specific principle can be found in the above description, which will not be repeated here.

In some embodiments, as shown in FIG. 8, the feeding point 300 is arranged at the first end portion of the first arc-shaped radiator 100, and the first grounding point 400 is arranged at the second end portion of the second arc-shaped radiator 200 (as shown in part (a) of FIG. 8). Or alternatively, the feeding point 300 is arranged at the second end portion of the first arc-shaped radiator 100, and the first grounding point 400 is arranged at the first end portion of the second arc-shaped radiator 200 (as shown in part (b) of FIG. 8). Or alternatively, the first grounding point 400 is arranged at the first end portion of the first arc-shaped radiator 100, and the feeding point 300 is arranged at the second end portion of the second arc-shaped radiator 200 (as shown in part (c) of FIG. 8). Or alternatively, the first grounding point 400 is arranged at the second end portion of the first arc-shaped radiator 100, and the feeding point 300 is arranged at the first end portion of the second arc-shaped radiator 200 (as shown in part (d) of FIG. 8).

Specifically, as shown in part (a) of FIG. 8, the feeding point 300 is arranged at the first end portion of the first arc-shaped radiator 100, and the first grounding point 400 is arranged at the second end portion of the second arc-shaped radiator 200. The first arc-shaped radiator 100 and the second arc-shaped radiator 200 form a right-hand circularly polarized antenna, which can receive a right-hand circularly-polarized signal (i.e., the first circularly-polarized signal).

As shown in part (b) of FIG. 8, the feeding point 300 is arranged at the second end portion of the first arc-shaped radiator 100, and the first grounding point 400 is arranged at the first end portion of the second arc-shaped radiator 200. The first arc-shaped radiator 100 and the second arc-shaped radiator 200 form a right-hand circularly polarized antenna, which can receive a right-hand circularly-polarized signal (i.e., the first circularly-polarized signal).

As shown in part (c) of FIG. 8, the first grounding point 400 is arranged at the first end portion of the first arc-shaped radiator 100, and the feeding point 300 is arranged at the second end portion of the second arc-shaped radiator 200. The first arc-shaped radiator 100 and the second arc-shaped radiator 200 form a left-hand circularly polarized antenna, which can receive a left-hand circularly-polarized signal (i.e., the first circularly-polarized signal).

As shown in part (d) of FIG. 8, the first grounding point 400 is arranged at the second end portion of the first arc-shaped radiator 100, and the feeding point 300 is arranged at the first end portion of the second arc-shaped radiator 200. The first arc-shaped radiator 100 and the second arc-shaped radiator 200 form a left-hand circularly polarized antenna, which can receive a left-hand circularly-polarized signal (i.e., the first circularly-polarized signal).

In some embodiments, the circularly polarized antenna further includes the third arc-shaped radiator 500. The third arc-shaped radiator 500, the first arc-shaped radiator 100, and the second arc-shaped radiator 200 are arranged at intervals. The third arc-shaped radiator 500, the first arc-shaped radiator 100, and the second arc-shaped radiator 200 are located on the same circumference, the third arc-shaped radiator 500 is provided with a second grounding point 600, and the third arc-shaped radiator 500 and the first arc-shaped radiator 100 are configured to receive the second circularly-polarized signal.

Specifically, the third arc-shaped radiator 500 is provided so that the third arc-shaped radiator 500 and the first arc-shaped radiator 100 can receive the second circularly-polarized signal, and the first arc-shaped radiator 100 and the second arc-shaped radiator 200 can receive the second circularly-polarized signal. In existing wearable electronic devices, a complete circular ring antenna can only receive a circularly-polarized signal of one frequency, while in the present application, three arc-shaped radiators (the first arc-shaped radiator 100, the second arc-shaped radiator 200 and the third arc-shaped radiator 500) are provided which can receive circularly-polarized signals of two frequencies, thus the number of received circularly-polarized signals is increased, thereby allowing the wearable electronic device to be positioned according to circularly-polarized signals of different frequencies. When a circularly-polarized signal of one frequency cannot be used, the wearable electronic device can use another circularly-polarized signal for positioning, which enhances the stability of the positioning function of the wearable electronic device.

Meanwhile, the three arc-shaped radiators (the first arc-shaped radiator 100, the second arc-shaped radiator 200 and the third arc-shaped radiator 500) are arranged at intervals, which increases the flexibility of the design of the three arc-shaped radiators in the wearable electronic device and reduces the difficulty of designing and installing the circularly polarized antenna.

In some embodiments, the arc length between the second end A of the first arc-shaped radiator 100 and the first end F of the third arc-shaped radiator 500 is smaller than the arc length between the first end B of the first arc-shaped radiator 100 and the second end E of the third arc-shaped radiator 500, and the arc angle on the circumference between the second end of the first arc-shaped radiator 100 and the first end of the third arc-shaped radiator 500 is greater than or equal to 10 degrees and smaller than or equal to 30 degrees.

Specifically, the arc length between the second end A of the first arc-shaped radiator 100 and the first end F of the third arc-shaped radiator 500 is smaller than the arc length between the first end B of the first arc-shaped radiator 100 and the second end E of the third arc-shaped radiator 500, and the arc angle on the circumference between the second end of the first arc-shaped radiator 100 and the first end of the third arc-shaped radiator 500 is greater than or equal to 10 degrees and smaller than or equal to 30 degrees. That is, the line connecting the second end A of the first arc-shaped radiator 100 and the center of the circumference is the third line, and the line connecting the first end F of the third arc-shaped radiator 500 and the center of the circumference is the fourth line, and the third line and the fourth line form the included angle which is greater than or equal to 10 degrees and smaller than or equal to 30 degrees. In addition to this, the included angle between the third line and the fourth line may also be configured to be greater than or equal to 10 degrees and smaller than or equal to 20 degrees. The included angle between the third line and the fourth line may also be configured to be greater than or equal to 15 degrees and smaller than or equal to 20 degrees. By reasonably configuring the included angle between the third and fourth lines, the third arc-shaped radiator 500 is brought close to the first arc-shaped radiator 100. In case that the feeding point 300 is provided on the first arc-shaped radiator 100, the first grounding point 400 is provided on the second arc-shaped radiator 200, and the second grounding point 600 is provided on the third arc-shaped radiator 500, then the first arc-shaped radiator 100 when receiving the second circularly-polarized signal can excite the third arc-shaped radiator 500 to generate a resonant current, so that the first arc-shaped radiator 100 and the third arc-shaped radiator 500 can receive the second circularly-polarized signal.

In case that the first grounding point 400 is provided on the first arc-shaped radiator 100, the feeding point 300 is provided on the second arc-shaped radiator 200, and the second grounding point 600 is provided on the third arc-shaped radiator 500, then the second arc-shaped radiator 200 when receiving the second circularly-polarized signal can excite the first arc-shaped radiator 100 to generate a resonant current, and then the first arc-shaped radiator 100 excites the third arc-shaped radiator 500 to generate a resonant current, thereby the first arc-shaped radiator 100 and the third arc-shaped radiator 500 can receive the second circularly-polarized signal.

In some embodiments, as shown in FIG. 9, the first grounding point 400 is arranged at the first end portion of the first arc-shaped radiator 100, the feeding point 300 is arranged at the second end portion of the second arc-shaped radiator 200, and the second grounding point 600 is arranged at the first end portion of the third arc-shaped radiator 500 (as shown in part (b) of FIG. 9). Or alternatively; the feeding point 300 is arranged at the first end portion of the first arc-shaped radiator 100, the first grounding point 400 is arranged at the second end portion of the second arc-shaped radiator 200, and the second grounding point 600 is arranged at the first end portion of the third arc-shaped radiator 500 (as shown in part (a) of FIG. 9).

Specifically, as shown in part (a) of FIG. 9, the feeding point 300 is arranged at the first end portion of the first arc-shaped radiator 100, the first grounding point 400 is arranged at the second end portion of the second arc-shaped radiator 200, and the second grounding point 600 is arranged at the first end portion of the third arc-shaped radiator 500. The first arc-shaped radiator 100 and the second arc-shaped radiator 200 form a right-hand circularly polarized antenna, which can receive right-hand circularly-polarized signals (i.e., first circularly-polarized signals). The second arc-shaped radiator 200 and the third arc-shaped radiator 500 form a right-hand circularly polarized antenna, which can receive a right-hand circularly-polarized signal (i.e., a second circularly-polarized signal).

As shown in part (b) of FIG. 9, the first grounding point 400 is arranged at the first end portion of the first arc-shaped radiator 100, the feeding point 300 is arranged at the second end portion of the second arc-shaped radiator 200, and the second grounding point 600 is arranged at the first end portion of the third arc-shaped radiator 500. The first arc-shaped radiator 100 and the second arc-shaped radiator 200 form a left-hand circularly polarized antenna, which can receive a left-hand circularly-polarized signal (i.e., a first circularly-polarized signal). The second arc-shaped radiator 200 and the third arc-shaped radiator 500 form a right-hand circularly polarized antenna, which can receive a right-hand circularly-polarized signal (i.e., a second circularly-polarized signal).

The present application also provides a wearable electronic device, which includes a housing, a position determination element, and the circularly polarized antenna as described above. The housing includes a bottom wall and a side wall connected to the bottom wall, the circularly polarized antenna is arranged on the side wall, and the position determination element is coupled with the circularly polarized antenna.

Specifically, the circularly polarized antenna is configured to receive the first circularly-polarized signal and transmit the first circularly-polarized signal to the position determination element, and the position determination element is configured to determine a current geographical location according to the first circularly-polarized signal. Since the circularly polarized antenna applied in the wearable electronic device of the embodiment of the present application utilizes two arc-shaped radiators (the first arc-shaped radiator and the second arc-shaped radiator) to form a circularly polarized antenna, there is no need to fabricate a complete annular radiator, which reduces the length of the antenna and is conducive to the miniaturization design of the circularly polarized antenna. Meanwhile, the two arc-shaped radiators can be flexibly designed within the wearable electronic device, which reduces the design difficulty of the circularly polarized antenna. For specific working principles, references may be made to the aforementioned description of the circularly polarized antenna, which will not be reiterated here.

The foregoing embodiments are only used to illustrate rather than limit the technical schemes of the present application. Although the present application is described in detail with reference to the above embodiments, ordinary technicians in this field should understand that: it is still possible to modify the technical schemes recorded in the above embodiments, or to replace some of the technical features therein by equivalent. These modifications or replacements do not make the essence of the corresponding technical schemes deviate from the spirit and scope of the technical schemes of the embodiments of the present application, and thus should all be included within the protection scope of the present application.

What is claimed is:

1. A circularly polarized antenna, comprising a first arc-shaped radiator and a second arc-shaped radiator, wherein the first arc-shaped radiator and the second arc-shaped radiator are arranged at an interval, the first arc-shaped radiator and the second arc-shaped radiator are located on a same circumference, one of the first arc-shaped radiator and the second arc-shaped radiator is provided with a first grounding point, another of the first arc-shaped radiator and the second arc-shaped radiator is provided with a feeding point, and the first arc-shaped radiator and the second arc-shaped radiator are configured to receive a first circularly-polarized signal.

2. The circularly polarized antenna according to claim 1, wherein an arc length between a first end of the first arc-shaped radiator and a second end of the second arc-shaped radiator is smaller than an arc length between a second end of the first arc-shaped radiator and a first end of the second arc-shaped radiator, and an arc angle on the same circumference between the first end of the first arc-shaped radiator and the second end of the second arc-shaped radiator is greater than or equal to 10 degrees and smaller than or equal to 30 degrees.

3. The circularly polarized antenna according to claim 1, wherein an equivalent length of the first arc-shaped radiator is equal to an equivalent length of the second arc-shaped radiator;
the feeding point is arranged at a first end portion of the first arc-shaped radiator, and the first grounding point is arranged at a first end portion of the second arc-shaped radiator;
or alternatively,
the feeding point is arranged at a second end portion of the first arc-shaped radiator, and the first grounding point is arranged at a second end portion of the second arc-shaped radiator;
or alternatively,
the first grounding point is arranged at the first end portion of the first arc-shaped radiator, and the feeding point is arranged at the first end portion of the second arc-shaped radiator;
or alternatively,
the first grounding point is arranged at the second end portion of the first arc-shaped radiator, and the feeding point is arranged at the second end portion of the second arc-shaped radiator.

4. The circularly polarized antenna according to claim 3, wherein the circularly polarized antenna further comprises a third arc-shaped radiator, the third arc-shaped radiator, the first arc-shaped radiator and the second arc-shaped radiator are arranged at intervals, the third arc-shaped radiator, the first arc-shaped radiator and the second arc-shaped radiator are located on the same circumference, and a second grounding point is provided on the third arc-shaped radiator; and
the third arc-shaped radiator and the first arc-shaped radiator are configured to receive a second circularly-polarized signal, or alternatively, the third arc-shaped radiator and the second arc-shaped radiator are configured to receive the second circularly-polarized signal.

5. The circularly polarized antenna according to claim 4, wherein an arc length between a second end of the first arc-shaped radiator and a first end of the third arc-shaped radiator is smaller than an arc length between a first end of the first arc-shaped radiator and a second end of the third arc-shaped radiator, and an arc angle on the same circumference between the second end of the first arc-shaped radiator and the first end of the third arc-shaped radiator is greater than or equal to 10 degrees and smaller than or equal to 30 degrees.

6. The circularly polarized antenna according to claim 5, wherein the first grounding point is arranged at the first end portion of the first arc-shaped radiator, the feeding point is arranged at the first end portion of the second arc-shaped radiator, and the second grounding point is arranged at a first end portion of the third arc-shaped radiator;
or alternatively,
the feeding point is arranged at the first end portion of the first arc-shaped radiator, the first grounding point is arranged at the first end portion of the second arc-shaped radiator, and the second grounding point is arranged at the first end portion of the third arc-shaped radiator.

7. The circularly polarized antenna according to claim 4, wherein an arc length between a first end of the second arc-shaped radiator and a second end of the third arc-shaped radiator is smaller than an arc length between a second end of the second arc-shaped radiator and a first end of the third arc-shaped radiator, and an arc angle on the same circumference between the first end of the second arc-shaped radiator and the second end of the third arc-shaped radiator is greater than or equal to 10 degrees and smaller than or equal to 30 degrees.

8. The circularly polarized antenna according to claim 7, wherein the feeding point is arranged at the first end portion of the first arc-shaped radiator, the first grounding point is arranged at the first end portion of the second arc-shaped radiator, and the second grounding point is arranged at a first end portion of the third arc-shaped radiator;
or alternatively,
the feeding point is arranged at the first end portion of the first arc-shaped radiator, the first grounding point is arranged at the first end portion of the second arc-shaped radiator, and the second grounding point is arranged at a second end portion of the third arc-shaped radiator.

9. The circularly polarized antenna claim 1, wherein an equivalent length of the first arc-shaped radiator is different from an equivalent length of the second arc-shaped radiator;
the feeding point is arranged at a first end portion of the first arc-shaped radiator, and the first grounding point is arranged at a second end portion of the second arc-shaped radiator; or alternatively,
the feeding point is arranged at a second end portion of the first arc-shaped radiator, and the first grounding point is arranged at a first end portion of the second arc-shaped radiator; or alternatively,
the first grounding point is arranged at the first end portion of the first arc-shaped radiator, and the feeding point is arranged at the second end portion of the second arc-shaped radiator; or alternatively,
the first grounding point is arranged at the second end portion of the first arc-shaped radiator, and the feeding point is arranged at the first end portion of the second arc-shaped radiator.

10. The circularly polarized antenna according to claim 9, wherein the circularly polarized antenna further comprises a third arc-shaped radiator, the third arc-shaped radiator, the first arc-shaped radiator and the second arc-shaped radiator are arranged at intervals, the third arc-shaped radiator, the first arc-shaped radiator and the second arc-shaped radiator are located on the same circumference, and a second grounding point is provided on the third arc-shaped radiator; and
the third arc-shaped radiator and the first arc-shaped radiator are configured to receive a second circularly-polarized signal.

11. The circularly polarized antenna according to claim 10, wherein an arc length between a second end of the first arc-shaped radiator and a first end of the third arc-shaped radiator is smaller than an arc length between a first end of the first arc-shaped radiator and a second end of the third arc-shaped radiator, and an arc angle on the circumference between the second end of the first arc-shaped radiator and the first end of the third arc-shaped radiator is greater than or equal to 10 degrees and smaller than or equal to 30 degrees.

12. The circularly polarized antenna according to claim 11, wherein the first grounding point is arranged at the first end portion of the first arc-shaped radiator, the feeding point is arranged at the second end portion of the second arc-shaped radiator, and the second grounding point is arranged at a first end portion of the third arc-shaped radiator;
or alternatively,
the feeding point is arranged at the first end portion of the first arc-shaped radiator, the first grounding point is arranged at the second end portion of the second arc-shaped radiator, and the second grounding point is arranged at a first end portion of the third arc-shaped radiator.

13. A wearable electronic device, comprising a housing, a position determination element and a circularly polarized antenna;
the circularly polarized antenna comprising a first arc-shaped radiator and a second arc-shaped radiator, wherein the first arc-shaped radiator and the second arc-shaped radiator are arranged at an interval, the first arc-shaped radiator and the second arc-shaped radiator are located on a same circumference, one of the first arc-shaped radiator and the second arc-shaped radiator is provided with a first grounding point, another of the first arc-shaped radiator and the second arc-shaped radiator is provided with a feeding point, and the first arc-shaped radiator and the second arc-shaped radiator are configured to receive a first circularly-polarized signal;
the housing comprising a bottom wall and a side wall connected to the bottom wall, wherein the circularly polarized antenna is provided on the side wall, and the position determination element is coupled with the circularly polarized antenna; and
the circularly polarized antenna is configured to receive the first circularly-polarized signal and transmit the first circularly-polarized signal to the position determination element, and the position determination element is configured to determine a current geographical location according to the first circularly-polarized signal.

14. The wearable electronic device according to claim 13, wherein an arc length between a first end of the first arc-shaped radiator and a second end of the second arc-shaped radiator is smaller than an arc length between a second end of the first arc-shaped radiator and a first end of the second arc-shaped radiator, and an arc angle on the same circumference between the first end of the first arc-shaped radiator and the second end of the second arc-shaped radiator is greater than or equal to 10 degrees and smaller than or equal to 30 degrees.

15. The wearable electronic device according to claim 13, wherein an equivalent length of the first arc-shaped radiator is equal to an equivalent length of the second arc-shaped radiator;
the feeding point is arranged at a first end portion of the first arc-shaped radiator, and the first grounding point is arranged at a first end portion of the second arc-shaped radiator;
or alternatively,
the feeding point is arranged at a second end portion of the first arc-shaped radiator, and the first grounding point is arranged at a second end portion of the second arc-shaped radiator;
or alternatively,
the first grounding point is arranged at the first end portion of the first arc-shaped radiator, and the feeding point is arranged at the first end portion of the second arc-shaped radiator;
or alternatively,
the first grounding point is arranged at the second end portion of the first arc-shaped radiator, and the feeding point is arranged at the second end portion of the second arc-shaped radiator.

16. The wearable electronic device according to claim 15, wherein the circularly polarized antenna further comprises a third arc-shaped radiator, the third arc-shaped radiator, the first arc-shaped radiator and the second arc-shaped radiator are arranged at intervals, the third arc-shaped radiator, the first arc-shaped radiator and the second arc-shaped radiator are located on the same circumference, and a second grounding point is provided on the third arc-shaped radiator; and
the third arc-shaped radiator and the first arc-shaped radiator are configured to receive a second circularly-polarized signal, or alternatively, the third arc-shaped radiator and the second arc-shaped radiator are configured to receive the second circularly-polarized signal.

17. The wearable electronic device according to claim 16, wherein an arc length between a second end of the first arc-shaped radiator and a first end of the third arc-shaped radiator is smaller than an arc length between a first end of the first arc-shaped radiator and a second end of the third arc-shaped radiator, and an arc angle on the same circumference between the second end of the first arc-shaped radiator and the first end of the third arc-shaped radiator is greater than or equal to 10 degrees and smaller than or equal to 30 degrees.

18. The wearable electronic device according to claim 17, wherein the first grounding point is arranged at the first end portion of the first arc-shaped radiator, the feeding point is arranged at the first end portion of the second arc-shaped radiator, and the second grounding point is arranged at a first end portion of the third arc-shaped radiator;
or alternatively,
the feeding point is arranged at the first end portion of the first arc-shaped radiator, the first grounding point is arranged at the first end portion of the second arc-shaped radiator, and the second grounding point is arranged at the first end portion of the third arc-shaped radiator.

19. The wearable electronic device according to claim 16, wherein an arc length between a first end of the second arc-shaped radiator and a second end of the third arc-shaped radiator is smaller than an arc length between a second end of the second arc-shaped radiator and a first end of the third arc-shaped radiator, and an arc angle on the same circumference between the first end of the second arc-shaped radiator and the second end of the third arc-shaped radiator is greater than or equal to 10 degrees and smaller than or equal to 30 degrees.

20. The wearable electronic device according to claim 19, wherein the feeding point is arranged at the first end portion of the first arc-shaped radiator, the first grounding point is arranged at the first end portion of the second arc-shaped radiator, and the second grounding point is arranged at a first end portion of the third arc-shaped radiator;
or alternatively,
the feeding point is arranged at the first end portion of the first arc-shaped radiator, the first grounding point is arranged at the first end portion of the second arc-shaped radiator, and the second grounding point is arranged at a second end portion of the third arc-shaped radiator.
